(19) United States
(12) Patent Application Publication
(10) Pub. No.: US 2017/0263082 A1
(43) Pub. Date: Sep. 14, 2017

(54) GAMING MACHINE

(71) Applicants: Universal Entertainment Corporation, Tokyo (JP); Aruze Gaming (Hong Kong) Limited, Hung Hom (HK)

(72) Inventors: Kenichi FUJIMORI, Tokyo (JP); Hiroaki KASHIMA, Tokyo (JP)

(21) Appl. No.: 15/454,330

(22) Filed: Mar. 9, 2017

(30) Foreign Application Priority Data
Mar. 10, 2016 (JP) 2016-046716

(51) Int. Cl. G07F 17/34; G07F 17/32

(52) U.S. Cl. CPC G07F 17/34; G07F 17/3227; G07F 17/3244; G07F 17/3288

(57) ABSTRACT

The present invention provides a gaming machine which may increase the upper limit of the normal payout in the condition of keeping the payout rate. The slot machine 1 comprises a control panel 30 receiving a first bet which is used to start to conduct a first game, and a touch panel 114 receiving a second bet which is used to start conduct a second game. The slot machine 1 performs a random determination with a predetermined winning probability and output the result of the second game after the control panel 30 receiving the first bet, and output the result of the second game which is certainly not the lucky number after the lower image display panel 141 receiving the second bet.

### CROSS REFERENCE TO RELATED APPLICATION

This application claims priority from Japanese Patent Application No. 2016-046716, filed on Mar. 10, 2016, which application is incorporated herein by reference in its entirety.

### TECHNICAL FIELD

The present invention relates to a gaming machine.

### BACKGROUND ART

In a specification of the US Patent Application Disclosure No. 2011/0118003, a gaming machine executing a normal game and giving a payout corresponding to a game result thereof is disclosed, wherein starting the normal game when a bet is accepted. In addition, in this gaming machine, a progressive payout (a progressive jackpot) is taken as a prize, and the progressive payout is different from a normal payout given according to the game result of the normal game. The progressive payout refers to a special payout, wherein in a gaming machine, a portion of the bet amount which is bet is accumulated, and when a predetermined condition comes into existence, a trigger is performed and a credit which is accumulated above is given.

### SUMMARY OF THE INVENTION

### Technical Problem

The normal payout generally limits a rate of the maximum number of payout to the bet amount, which may loss the customers who scruple the limitation mentioned above.

For this purpose, the goal of the present invention is to provide a gaming machine which may increase the upper limit of the normal payout in the condition of keeping the payout rate.

### Technical Solution

The gaming machine of the present invention comprises:

a first bet receiving device which receives a first bet for starting to conduct a first game;
a second bet receiving device which receives a second bet for starting to conduct a second game; and
a controller performing the following process,
the controller performing a random determination of a predetermined winning probability and
outputting the result of the second game after the first bet receiving device receiving the first bet,
outputting the result of the second game which is certainly not the lucky number after the second bet receiving device receiving the second bet.

According to the structure mentioned above, the gaming machine can perform the first game which is the lucky number with the predetermined probability, and also can perform the second game which is certainly not the lucky number. The rate of the maximum number of payout to the bet amount is generally limited, however, because the game result of the second game is certainly not the lucky number, the bet amount in the first game corresponding to the maximum number of payout can be increased correspondingly. Therefore, the upper limit of the number of payout of the gaming machine may be increase in the condition of keeping the overall payout rate of the gaming machine.

The present invention is the gaming machine mentioned above, wherein, comprising a storage unit,

the controller calculating the accumulative value of the bet amount in the second game,
the storage unit storing the accumulative value calculated by the controller.

According to the structure mentioned above, the second game is a game which always doesn't have a payout regardless of the number of the bet amount, and therefore the accumulative value which has been bet in the second game may be regarded as a credit for a fundraising. Therefore, it is easy to embed a fundraising system into the gaming machine.

In addition, the present invention is the gaming machine mentioned above, wherein, the controller allows to receive the second bet at a settlement timing.

According to the structure mentioned above, because of allowing to receive the second bet at the settlement timing, a player may conduct the second game after conducting the first game without conducting the first game again. Therefore, a condition of the bet amount required when conducting the first bet being insufficient may be avoided, and it may quite naturally urge the player to conduct a fundraising.

In addition, the present invention is the gaming machine mentioned above, wherein, the controller

storing the payout into the credit accumulatively in the condition of the result of the first game being to give the payout, and wherein the credit is to be stored in the storage unit,
prompting a broken number of the credit as an option of the bet amount of the second bet when starting the second game.

According to the structure mentioned above, the player may not only conduct a settlement for a desired credit but also easily conduct the fundraising with an unwanted broken number by betting the broken number into the second game under the condition the player expects a suitable number of payout.

In addition, the present invention provides a game system, wherein, comprising a plurality of gaming machines which may perform various games including certain games each of which is certainly not the lucky number, and a host server connected with the plurality of gaming machines with a manner of being able to perform a data communication and managing the money information of the plurality of gaming machines,

the plurality of gaming machines respectively
sending the type of the game which is conducted and the bet amount and the number of payout in the game which is conducted to the host server,
the host server calculating the bet amount and the number of payout received from the plurality of gaming machines for each of the games and storing them.

According to the structure mentioned above, in the gaming machine, various games include a certain game which is certainly not the lucky number. The rate of the maximum number of payout to the bet amount is generally limited, however, because the game result of the certain game is certainly not the lucky number, the maximum number of payout corresponding to the bet amount in other type of game can be increased correspondingly. Therefore, the upper limit of the number of payout of the gaming machine may be increase in the condition of keeping the overall payout rate of the gaming machine.

In addition, the present invention provides a game system, wherein,

comprising a plurality of gaming machines which may perform various games including certain game, and a host server connected with the plurality of gaming machines with a manner of being able to perform a data communication and managing the money information of the plurality of gaming machines,
the plurality of gaming machines respectively comprising:
a storage unit which is used to store the plurality of games including the certain game; and
a controller which is used to perform the following process,
the controller
sending a command to the host server when starting the certain game, and the command contains the bet amount, the credit amount after the bet amount is subtracted and the information of the content indicating that the certain game is to start,
sending a command to the host server when terminating the certain game, and the command contains the game result which is used to indicate that it is no payout all the time and the information which is used to indicate that the certain game is to be terminated.

According to the structure mentioned above, various games may be conducted in the gaming machine, which include the certain game. The rate of the maximum number of payout to the bet amount is generally limited, however, because the game result of the certain game is certainly to be no payout, the maximum number of payout corresponding to the bet amount in other type of game can be increased correspondingly. Therefore, the upper limit of the number of payout of the gaming machine may be increase in the condition of keeping the overall payout rate of the gaming machine.

As mentioned above, according to the present invention, it may increase the upper limit of the normal payout in the condition of keeping the payout rate.

### BRIEF DESCRIPTION OF THE DRAWINGS

FIG. 1 is a diagram showing game contents of a slot machine.

FIG. 2 is a diagram showing a functional flow of the slot machine.

FIG. 3 is a diagram showing a game system including the slot machine.

FIG. 4 is a diagram explaining the signal transmitted-received between a host server and the slot machine in the present invention.

FIG. 5 is a diagram showing an example of an exception code.

FIG. 6 is a diagram showing an example of an exception code signal.

FIG. 7 is a diagram showing an example of an exception code signal.

FIG. 8 is a diagram showing an example of an exception code signal.

FIG. 9 is a diagram showing an example of a long poll command.

FIG. 10 is diagram showing an example of a gaming machine message signal.

FIG. 11 is diagram showing an example of a gaming machine message signal.

FIG. 12 is a diagram showing an example of a fundraising confirming image.

FIG. 13 is a diagram showing a flowchart of a fundraising process of the slot machine.

FIG. 14 is a diagram showing a flowchart of a second game conducting process of the slot machine.

FIG. 15 is a diagram showing a slot machine money management table.

FIG. 16 is a diagram showing an overall structure of the slot machine.

FIG. 17 is a diagram showing a control panel of the slot machine.

FIG. 18 is a block diagram showing an internal structure of the slot machine.

FIG. 19 is a diagram showing a symbol array described on a circumferential surface of a reel of the slot machine.

FIG. 20 is a diagram showing a symbol combination table of the slot machine.

FIG. 21 is a diagram showing a flowchart of a main control process of the slot machine.

### DESCRIPTION OF EMBODIMENTS

### Summary of the Present Invention

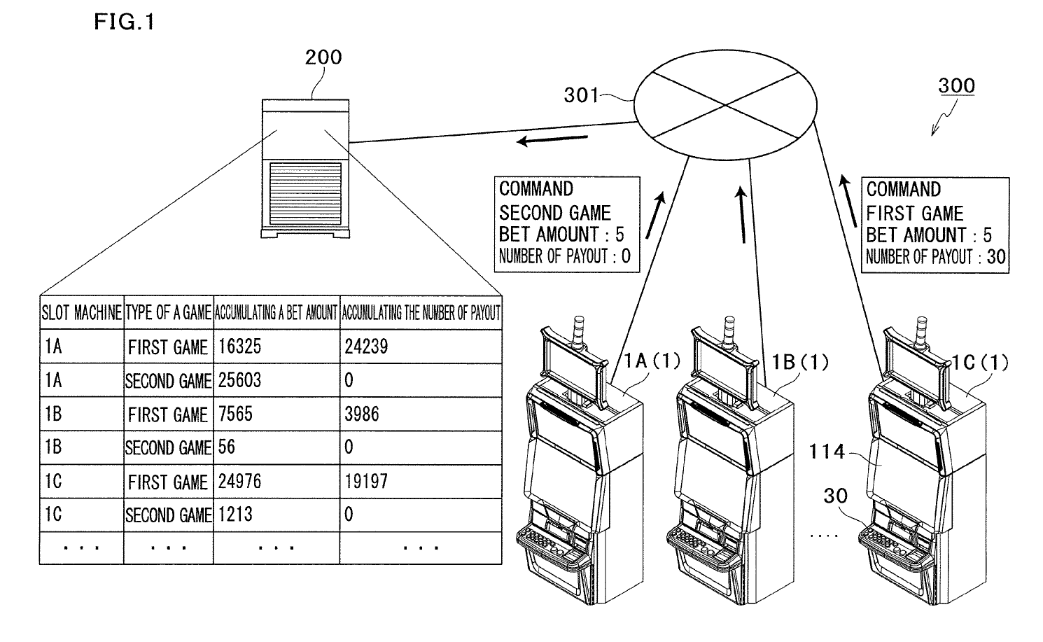

The embodiment of the present invention will be illustrated according to the drawings as follows. FIG. 1 is a diagram showing the outline of the game contents of the slot machine 1 (the gaming machine) of the embodiment of the present invention. As shown in FIG. 1, the slot machine 1 (the slot machines 1A, 1B, 1C) of the embodiment of the present invention is configured to be able to conduct various games including a certain game therein which is certainly not the lucky number, and thus the upper limit of the number of payout of other type of games except for the certain game is increased and the overall payout rate is kept.

To be more specific, the slot machine 1 comprises a first bet receiving device (a control panel 30) receiving a first bet which is used to start to conduct a first game (a normal game), and a second bet receiving device (a touch panel 114) receiving a second bet which is used to start conduct a second game (a certain game). The slot machine 1 performs a random determination of a predetermined winning probability and outputs the result of the second game after the first bet receiving device receiving the first bet, In addition, the slot machine 1 outputs the result of the second game which is certainly not the lucky number after the second bet receiving device receiving the second bet.

Wherein, the result of the second game as the certain game is to be absolutely not the lucky number. That is to say, the number of payout (sometimes also referred as a payout amount, payout amount and so on) is certainly to be “zero”, which has nothing to do with the bet amount which is bet by a player in the second game (sometimes also referred as the bet amount). In addition, the second game is not limited to display a game effect image which may be observed by a player with the eye. That is to say, an internal process program is performed in the second game without displaying a image such as the reel rotating, and the internal process program outputs a number of payout of zero as the result of the game. That is to say, “the output of the game result of the second game” may also be not recognized by the player. In addition, when performing “the output of the game result of the second game”, a random determination may be performed or not, and the random determination is referred to the winning such as that to be certainly not the lucky number.

In addition, except for the first game and the second game, the gaming machine may further comprise other different games. The first game and the second game start to manage under the condition of bet and may further comprise a free game and a bonus game such as that without the condition of bet. In addition, a plurality of the first games which are under the condition of bet may be presented in one gaming machine.

In addition, in the present embodiment, the first bet receiving device and the second bet receiving device may be different devices respectively and may also be the same device. That is to say, one device may have the function of each of the first bet receiving device and the second bet receiving device.

As mentioned above, the slot machine 1 is configured to be able to perform the first game which is the lucky number with the predetermined probability, and also able to perform the second game which is certainly not the lucky number. The rate of the maximum number of payout to the bet amount is generally limited, however, because the game result of the second game is certainly not the lucky number, the bet amount in the first game corresponding to the maximum number of payout can be increased correspondingly. Therefore, the upper limit of the number of payout of the gaming machine may be increase in the condition of keeping the overall payout rate of the gaming machine.

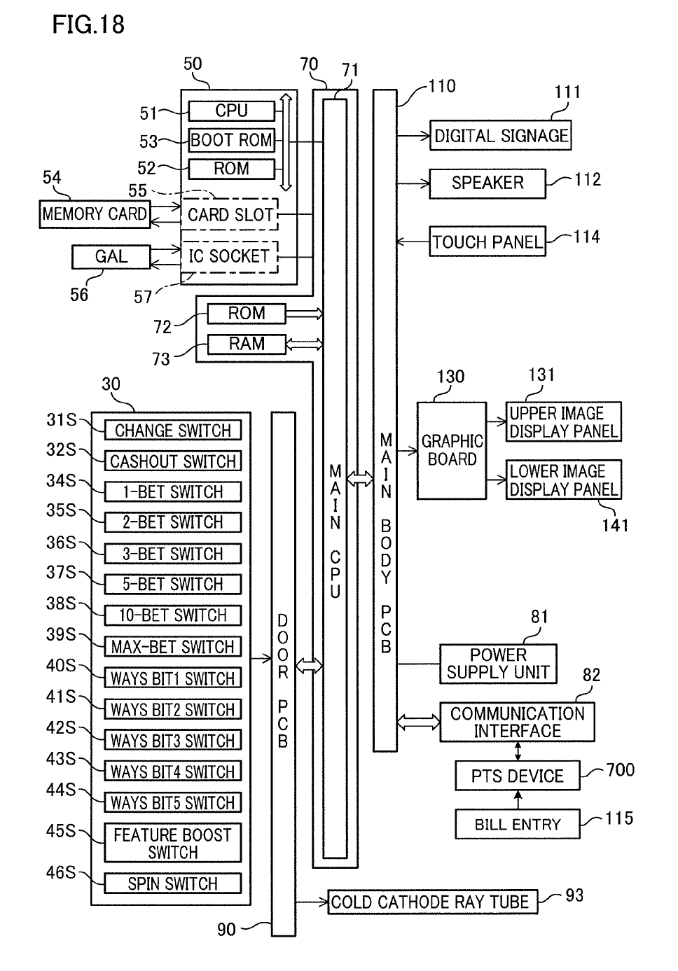

In addition, the slot machine 1 further comprises a storage unit (a RAM 73 shown in FIG. 18 described later and so on) calculating an accumulative value of the bet amount in the second game, and the storage unit stores the accumulative value which is calculated. To be more specific, the slot machine 1 takes the bet amount of the second game as a fundraising to be stored accumulatively. Therefore, it is easy to embed a fundraising system into the gaming machine.

In addition, the slot machine 1 allows to receive the second bet at the settlement timing. As mentioned above, because of allowing to receive the second bet at the settlement timing, a player may conduct the second game after conducting the first game without conducting the first game again. Therefore, a condition of the bet amount required when conducting the first bet being insufficient may be avoided, and it may quite naturally urge the player to conduct a fundraising.

In addition, in the slot machine 1, if the result of the first game is to give a payout, the payout is stored accumulatively into the credit which will be stored in the storage unit, and the broken number of the credit is prompted as a option of the bet amount of the second bet when starting the second game. As mentioned above, the player may not only conduct a settlement for a desired credit but also easily conduct the fundraising with an unwanted broken number by betting the broken number into the second game under the condition the player expects to perform the settlement with a suitable number of payout. In addition, the so-called credit refers to electronic information of price put into the slot machine 1 by a player, performing a subtracting process when betting and performing an adding process when giving a payout.

In addition, the slot machine 1 is disposed to have multiple which may be connected with a host server (the host server 200) in a manner that is able to perform a data communication, and the host server manages the money information. A game system 300 is configured to comprise a plurality of slot machines 1 and the host server 200 as mentioned above, and the host server 200 is connected with each of the slot machines 1 through a communication line 301.

The slot machine 1 sends the type of the game which is conducted and the bet amount and the number of payout in the game which is conducted to the host server 200. The host server 200 calculates the count of the bet amount and the number of payout received from the plurality of gaming machines 1 for each of the games and storing them.

To be more specific, the plurality of slot machines 1 comprise the storage unit respectively, which stores various games including the certain game therein, sending a command to the host server when starting the certain game, and the command contains the bet amount, the credit amount after the bet amount is subtracted and the information of the content indicating that the certain game is to start. Besides, the plurality of slot machines 1 send a command to the host server respectively when terminating the certain game, and the command contains the game result which is used to indicate that it is no payout all the time and the information which is used to indicate that the certain game is to be terminated.

That is to say, the plurality of slot machines 1 perform a random determination of the predetermined winning probability and output the result of the second game after the first bet receiving device receiving the first bet, and output the result of the second game which is certainly not the lucky number after the second bet receiving device receiving the second bet. Then, the plurality of slot machines 1 send the type of the game, the bet amount and the number of payout to the host server 200 respectively when conducting the game for each time. The host server 200 calculates the bet amount and the number of payout received from the plurality of gaming machines and stores them according to the kind of the game.

As mentioned above, the plurality of slot machines 1 are configured to be able to perform the first game which is the lucky number with the predetermined probability, and also able to perform the second game which is certainly not the lucky number. The host server 200 calculates the bet amount and the number of payout received from the slot machine 1 and stores them according to the kind of the game, and the host server 200 may be data communicated with the plurality of slot machines 1. The rate of the maximum number of payout to the bet amount is generally limited, however, because the game result of the second game is certainly not the lucky number, the bet amount in the first game corresponding to the maximum number of payout can be increased correspondingly. Therefore, the upper limit of the number of payout of the slot machine 1 may be increase in the condition of keeping the overall payout rate of each of the slot machines 1. Besides, the host server 200 stores the bet amount and the number of payout of each of the slot machines 1 according to the kind of the game, and thus it is easy to calculate the total number of the bet amount of the second game in each of the slot machines 1. For example, when the contribution is performed with taking the bet amount of the second game as the fundraising, it is easy to add up for it in the host server 200.

### Definition, Etc.

In the present embodiment, the slot machine 1 is illustrated as an example of a gaming machine, but the present invention is not limited thereto. A normal game in the present embodiments is conducted by the slot machine 1. The normal game is a slot game which performs a rearrangement for a plurality of symbols. In addition, the rearrangement of the symbols is performed by a video reel in the slot game. The normal game is such a kind of game that performs the rearrangement for the symbol rearrangement in a display window through the video reel under the condition of the bet of the gaming value and gives a payout corresponding to the symbols which are rearranged. A free game refers to a game which may be conducted with betting a less gaming value with respect to the normal game. If it is a different game state from the normal game, the free game may be any kind of game. The so-called “conducted with betting a less gaming value” also comprises the case that the bet is “zero”. Therefore, the “free game” may also be such a kind of game that may be conducted without taking the bet of the gaming value as the condition and pays out the quantity of the gaming value corresponding to the symbols which are rearranged. In other words, the so-called “free game” may also be a game starting to conduct without taking the consume of the gaming value as the precondition. With respect to the “free game”, the “normal game” is such a kind of game that is conducted with taking the bet of the gaming value as the condition and pays out the quantity of the gaming value corresponding to the symbols which are rearranged. In other words, the so-called “normal game” is a game starting to conduct with taking the consume of the gaming value as the precondition. In addition, the “free game” is a game shifting under the condition that the predetermined condition (a free game trigger) is met in the normal game.

The gaming value is electronic information of price such as electronic money. Besides, there is no particular limitation to the gaming value in the present invention, for example, it may be a gaming media such as a coin, a medal, a token, a ticket, etc. There is no particular limitation to the ticket, and it may be a ticket with a bar code, etc., and the bar code is formed by encoding the data such as the credit amount, etc. Further, the “gaming value” may also be a game point which does not have information of price.

The so-called rearrangement means a state in which symbols are rearranged after the configuration of the symbols is dismissed. The so-called configuration means a state in which a player outside may confirm the symbols through a visual method. Specifically, the rearrangement is a state in which a reel stops rotating and a scroll-display of symbols stops after the symbols on the reel scroll-display as the reel rotates, and thereby the symbols stop within the display window.

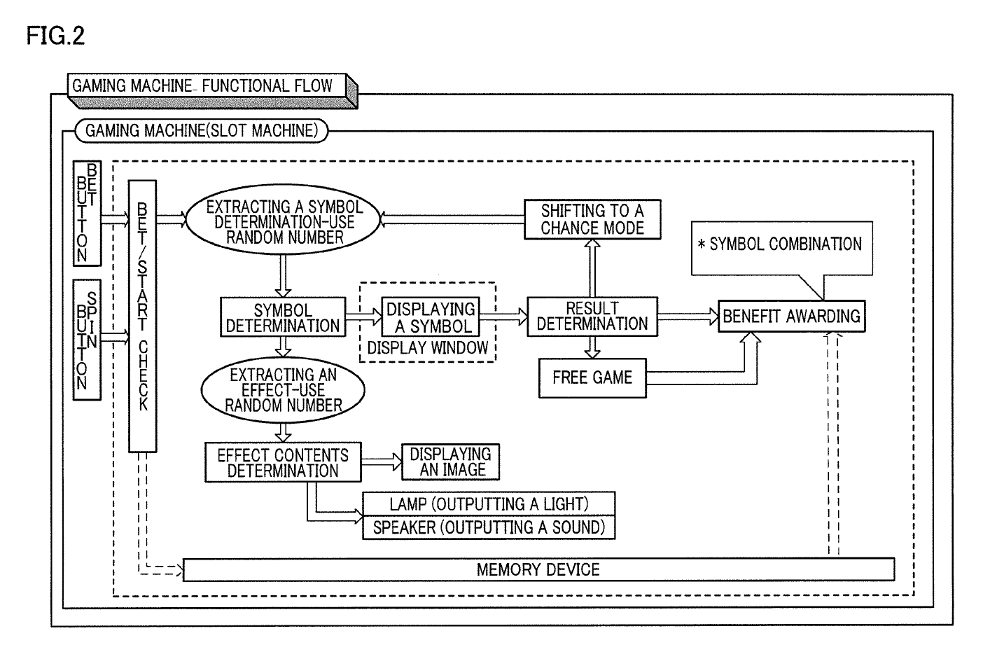

(Illustration of the Functional Flow Chart) Refer to the FIG. 2, fundamental function of the slot machine of an embodiment of the present invention is illustrated. FIG. 2 is an illustrative diagram showing a functional flow of the slot machine of an embodiment of the present invention.

(Bet/Start Check)

First of all, the slot machine checks whether the player has pressed the BET button or not, and next checks whether the player has pressed the spin button.

(Symbol Determination)

Next, when the spin button is pressed by the player, the slot machine determines the symbols which will be rearranged in the display window from a plurality of symbols with the manner of a random determination, and the plurality of symbols include the predetermined symbols which are arrayed in the normal mode video reel therein.

(Reel Display Control)

Next, the slot machine rotates various reels and controls the various reels to stop them to display the determined symbols to the player through the display window (symbol display).

(Result Determination)

Next, the slot machine judges whether a combination of the symbols displayed to the player is the symbol combination of winning when the various reels stop rotating.

(Benefit Awarding)

Next, when the combination of the symbols which are displayed to the player is the symbol combination of winning, the slot machine gives a benefit corresponding to the kind of the symbol combination to the player. For example, if a symbol combination related to the credit awarding is displayed, the slot machine gives the number of the credit corresponding to the symbol combination to the player. In addition, in the normal mode, if the combination of the predetermined symbols comes into existence, the free game is given.

In addition, under the condition of the predetermined condition is met when performing the result determination, the slot machine shifts from the normal mode to a chance mode with the manner of the random determination. When performing the chance mode, the symbols which will be rearranged in the display window are determined from a plurality of symbols with the manner of the random determination, and the plurality of symbols are arrayed in the chance mode video reel. In addition, in the chance mode, if the combination of the predetermined symbols comes into existence, the free game is given.

Besides, except the above benefit, a benefit such as mystery bonus, insurance and the like may be disposed in the slot machine. The mystery bonus is such a kind of benefit in which a predetermined number of coin is paid out if it is the lucky number when performing the special random determination. The slot machine extracts a random number for the mystery bonus and determines whether a mystery bonus trigger comes into existence through the random determination when the spin button is pressed.

The insurance is a function which is for the purpose of relieving the player under the case that the free game is not conducted for a long time. The manager of the slot machine may arbitrarily select whether the insurance is validated or not. In the case that the insurance is validated, it may be exchanged with the predetermined insurance activation amount. In the case that the insurance is effective, the slot machine starts to count the number of times of the game. Then, the slot machine does not perform a large sum of payout, and when the number of times of the game which is counted reaches the predetermined number of times, the payout may be set to be the amount of the coin for the insurance.

(Effect Determination)

The slot machine performs an effect by an image display based on a display, a light output based on a lamp and a sound output based on a speaker. The slot machine extracts an effect-use random number and determines the effect contents according to symbols determined by the random determination.

(Overall Structural of the Game System)

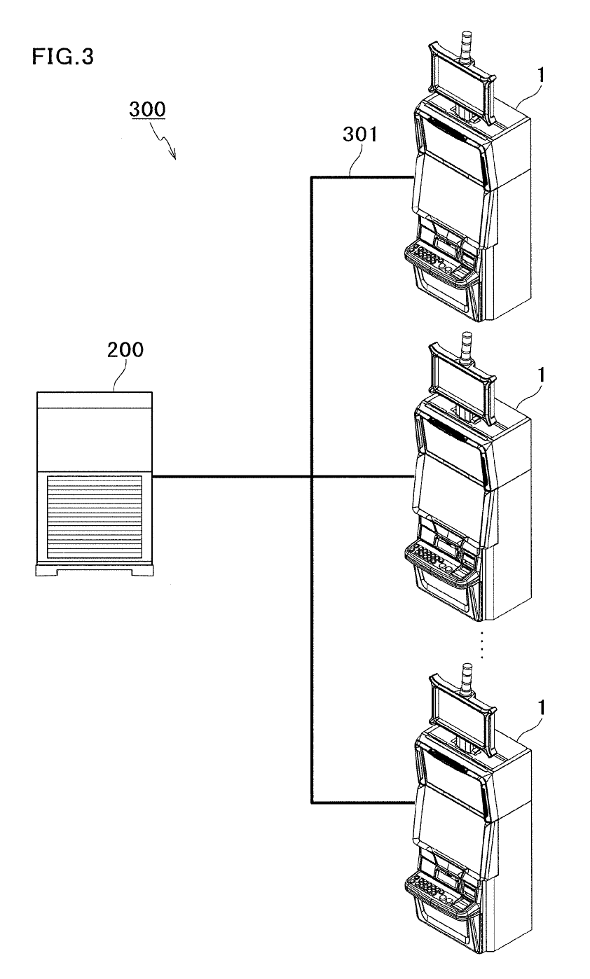

The fundamental function of the slot machine is illustrated above. Next, refer to the FIG. 3, the game system including a slot machine therein is illustrated. FIG. 3 is a diagram showing the game system including a slot machine of the present embodiment.

The game system 300 comprises a plurality of slot machines 1 and the host server 200, and the host server 200 is connected with each of the slot machines 1 through a communication line 301.

The host serve 200 controls the plurality of slot machines 1. In the embodiments of the present invention, the host server 200 is a so-called hall server which is disposed in a gaming facility comprising a plurality of slot machines 1. Each of the slot machines 1 is given an inherent identification number respectively, and the host server 200 performs a provenance discrimination for the data sent from respective slot machines 1. In addition, when the data is sent from the host server 200 to the slot machine 1, the sending destination is assigned with the identification number.

In addition, the game system 300 may be disposed in one gaming facility which may conduct various games such as casino, etc., and may also be disposed among a plurality of gaming facilities. In addition, in the case that the game system 300 is disposed in one gaming facility, it may be disposed in respective floors or respective sections of the gaming facility. The communication line 301 may be a wired or may be wireless, and it may adopt an exclusive line or a switched line, etc.

In addition, the game system 300 mentioned above is a network connection type of connecting the plurality of slot machines 1 and the host server 200 through the communication line 301, however, the slot machine 1 may be a stand-alone type of conducting a game independently.

(The Communication of Event Information)

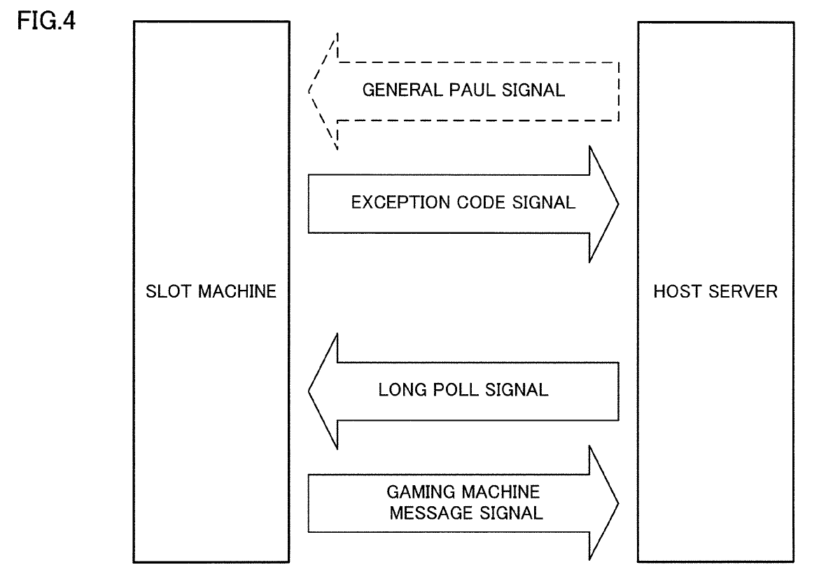

FIG. 4 is a diagram explaining the signal transmitted-received between the host server 200 and the slot machine 1. As shown in FIG. 4, in the slot machine 1, in the condition that an event which is to be sent to the host server 200 occurs, an exception code signal is sent as a command from the slot machine 1 to the host server 200. The exception code signal is a signal containing an event code, and the event code is mainly used to denote the event type.

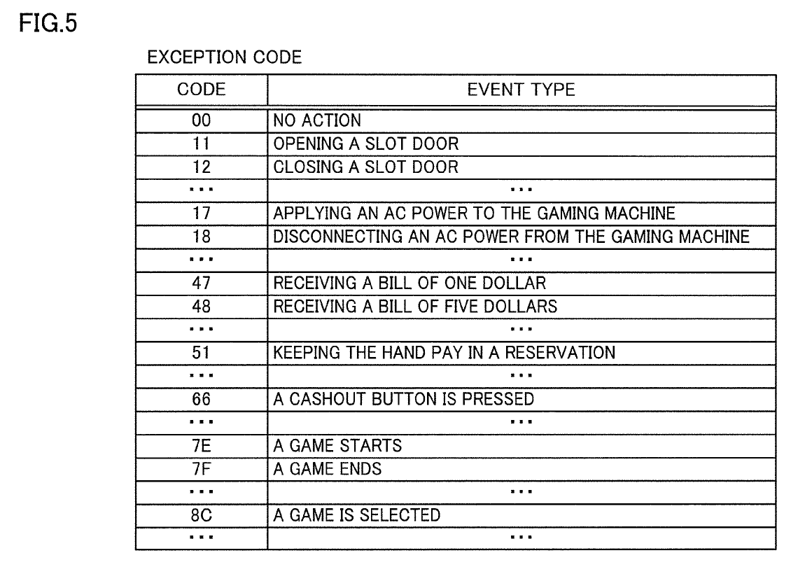

To be more specific, as shown in FIG. 5, for example, the exception code signal is information which denotes that a game which is to be conducted is selected in the slot machine 1, information which denotes that a game starts to be conducted in the slot machine 1, information which denotes that an aftermentioned main door 13 has been opened in the slot machine 1, information which denotes that the slot machine 1 receives a bill paid by a player, information which denotes that a game is retained for performing the Hand Pay, etc. As mentioned above, the exception code signal generates one signal for each of the events.

In addition, the slot machine 1 may be further configured to send the exception code signal regarding it as the chance when a general poll signal is received from the host server 200. The general poll signal is a signal as a command for the host server 200 inquiring the slot machine 1 whether a certain event occurs or not. In this case, the host server 200 may send a general pole signal which is used to request the event information to each slot machine 1 in the plurality of slot machines 1 managed by the host server 200 at fixed periods. The slot machine 1 accumulates the event information of the predetermined type occurred before receiving the general pole signal. As a response to the general pole signal, the slot machine 1 sends the event information of the predetermined type which is accumulated as the exception code signal to the host server 200. In addition, in the case that the event information is not accumulated, the slot machine 1 sends the exception code signal which is used to denote that the event is not present to the host server 200. In the case that the real-time event report is Disable, the slot machine 1 sends the exception code signal of single byte regarding it as the chance when receiving the general pole signal. The enable/disable of the real-time event report is switched according to a long poll signal from the host server 200 which will be described in the below.

In addition, the exception code signal may be an exception message including a plurality of information, and may also be an exception code of single byte. To be more specific, the exception message contains the address of the slot machine 1, the event response identifier, the exception code, other additional data, and CRC (Cyclic Redundancy Check) of 2 bytes (16 bits).

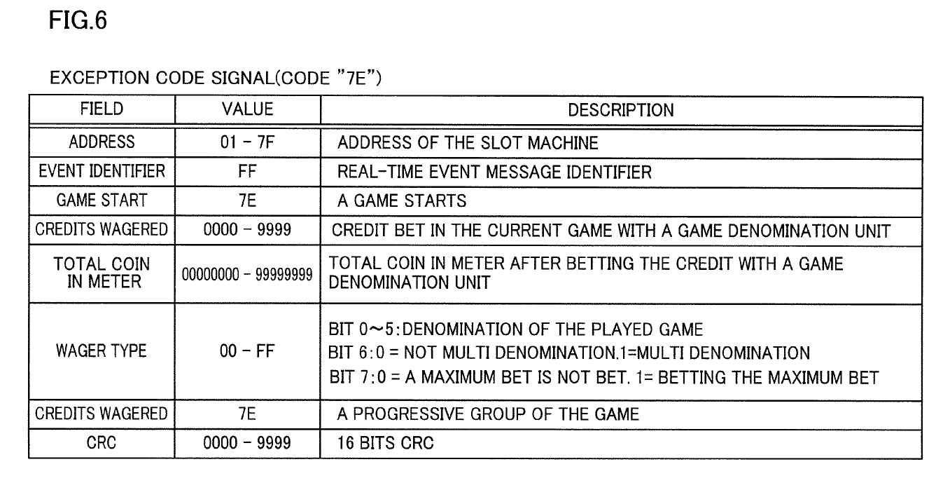

To be more specific, as shown in FIG. 6, the exception code signal which is sent to the host server 200 by the slot machine 1 at the timing of starting the game contains the address of the slot machine 1, the exception code (code “7E”) which is used to denote to start the game, the credit (bet amount) of the bet in the current game, and the credit amount after subtracting the bet amount. The address of the slot machine 1 is respective inherent identifiers set for the plurality of slot machines 1, and the plurality of slot machines 1 are connected with the host server 200 with a manner that is able to perform the data communication.

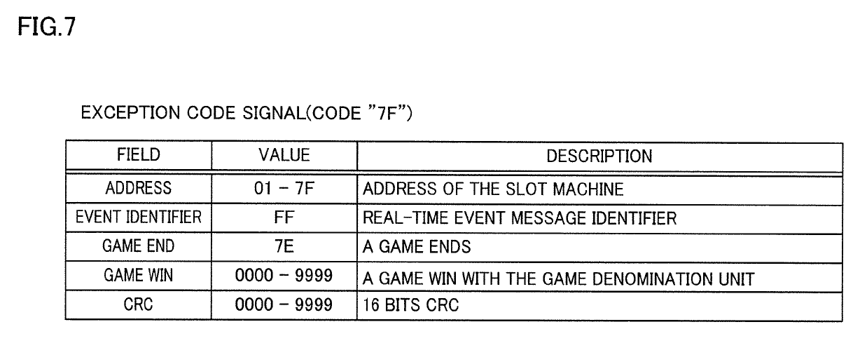

In addition, as shown in FIG. 7, the exception code signal which is sent to the host server 200 by the slot machine 1 at the timing of terminating the game contains the address of the slot machine 1, the exception code (code “7F”) which is used to denote to terminate the game, and the game-win (number of payout).

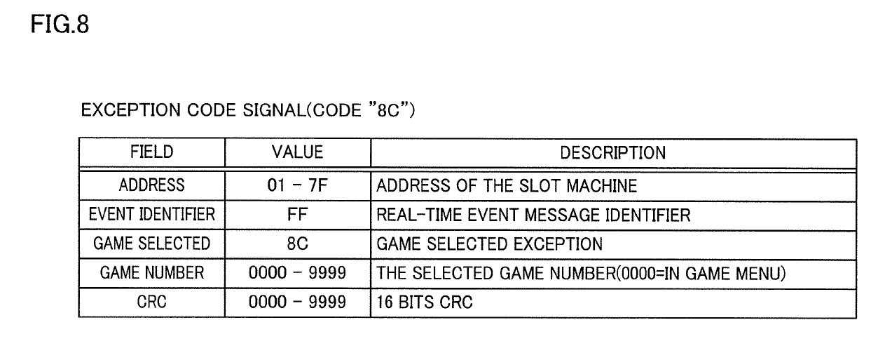

In addition, as shown in FIG. 8, the exception code signal which is sent to the host server 200 by the slot machine 1 at the timing of choosing the type of the game contains the address of the slot machine 1, the exception code (code “8C”) which is used to denote the selected game, and the game number which is used to denote the selected game.

(The Communication of Accounting Information)

For example, the host server 200 sends the long poll signal as a command to the slot machine 1 under the condition that the host server 200 wants to control the slot machine 1, under the condition that the host server 200 wants to send information to the slot machine 1, under the condition that the host server 200 wants to acquire information (the accounting information) from the slot machine 1, and so on.

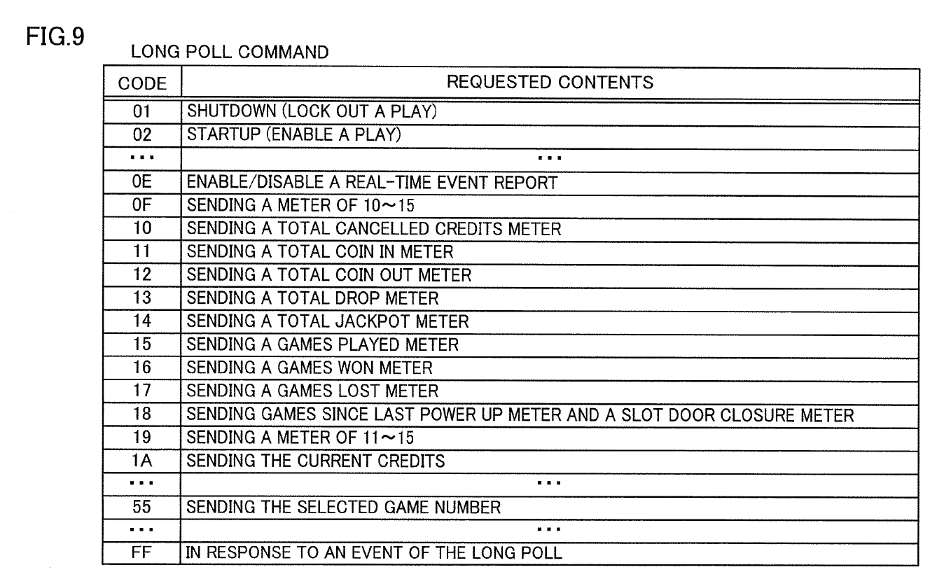

To be more specific, as shown in FIG. 9, for example, the long poll signal is a command which is used to cause the slot machine 1 to shut down (cause the pay to lock out), a command which is used to cause the slot machine 1 to start up (cause the pay to enable), a command which is used to switch the enable/disable of the real-time event report in the slot machine 1, a command which is used to request the bet amount (Coin In) or the number of payout (Coin Out), and so on.

As a response to the long poll signal, the slot machine 1 sends a gaming machine message signal containing the accounting information therein as a command to the host server 200. The gaming machine message signal contains the address of the slot machine 1, the host command, the accounting information which is requested, and the CRC of 2 bytes.

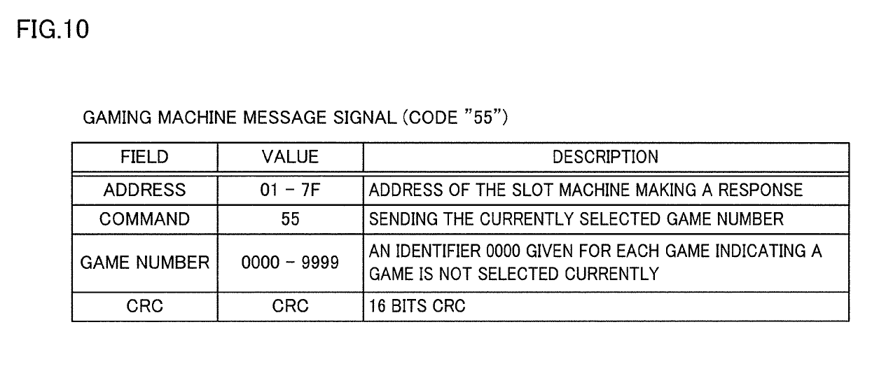

For example, as shown in FIG. 10, when the host server 200 sends a long poll signal of code “55”, as a response to this long poll signal, the slot machine 1 sends the gaming machine message signal including the information of the selected game number therein to the host server 200. In addition, if any game is not selected, the game number is set to be “0000” for the gaming machine message signal. In addition, in the present embodiment, the game number of the normal game (the first game) is set to be “0001”, and the game number of the certain game (the second game) is set to be “9999”.

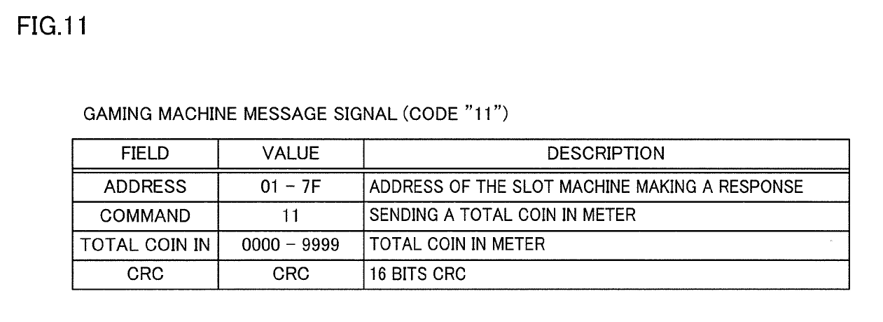

In addition, as shown in FIG. 11, when the host server 200 sends a long poll signal of code “11”, as a response to this long poll signal, the slot machine 1 sends the gaming machine message signal including the information of the total Coin In (the credit amount after subtracting the bet amount) therein to the host server 200.

(Fundraising System)

In the present embodiment, the slot machine 1 is configured to comprise the fundraising system with the second game in which the number of payout is certainly to be zero. As mentioned above, the host server 200 manages the slot machine 1 regarding the addition/subtraction of the credit (the decrease of the credit due to the bet, and the increase of the credit due to the payout). Therefore, even if the slot machine 1 simply receives the fundraising and performs the subtracting for the credit, the fundraising becomes the money for unexplained purposes in the host server 200 because the fundraising unrelated to the game cannot be received by the host server 200. Therewith, the fundraising amount may be managed in the host server 200 by receiving the fundraising and taking it as the bet of the second game in which the number of payout is certainly to be zero.

(Fundraising System: Fundraising Confirmation Screen)

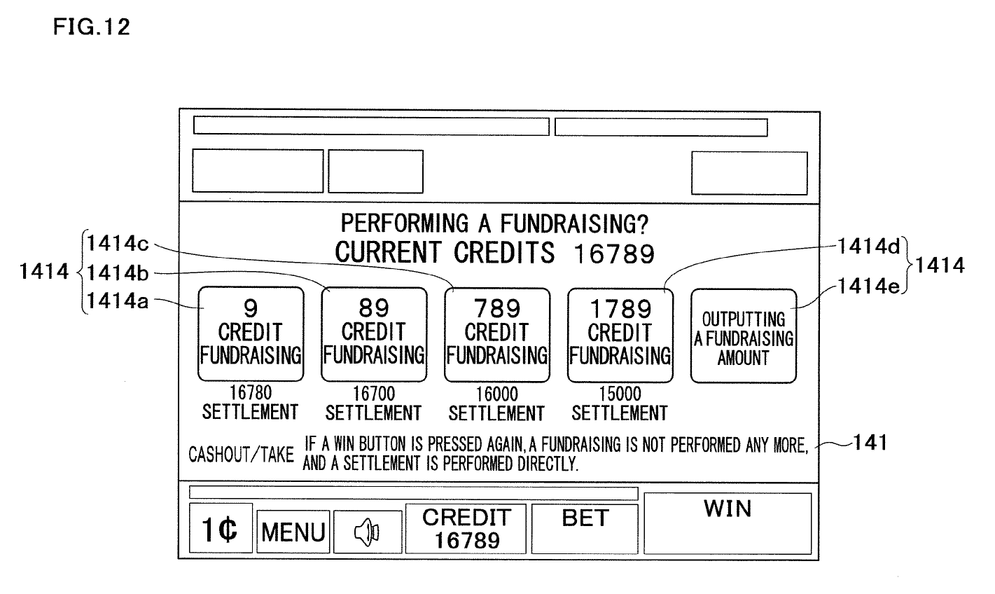

As shown in FIG. 12, when a player presses an aftermentioned CASHOUT/TAKE WIN button 32 to perform the settlement for the credit, a fundraising confirmation screen which is used to confirm whether the fundraising is performed is displayed in a lower image display panel 141. The lower image display panel 141 displays five option images 1414 (option images 1414a, 1411b, 1411c, 1411d, 1411e) which are used to select the fundraising amount. Respective option images 1414 display information which is used to denote the fundraising amount or information which is used to denote that the fundraising amount is input by oneself. In the case that a player touches the option image 1414 in which the information which is used to denote the fundraising amount is displayed, the fundraising is performed for the fundraising amount displayed in this option image 1414, and the settlement is performed for the remaining credit after subtracting the fundraising amount. In the case that a player touches the option image 1414 in which the information which is used to denote that the fundraising amount is input by oneself is displayed, a numeric keypad image which is not shown is displayed, the player decides the fundraising amount freely, and the settlement is performed for the remaining credit after subtracting the fundraising amount. The fundraising amount selected or input through the option image 1414 by the player is accepted by a touch panel 114. In addition, in the fundraising confirmation screen, if the CASHOUT/TAKE WIN button 32 is pressed again, the fundraising is not performed any more, and the settlement is performed for the credit according to the value of the credit directly. In addition, the contents mentioned above is displayed in the fundraising confirmation screen.

Wherein, regarding the fundraising amount (the bet amount of the second game) displayed in the option image 1414, the broken number of the credit amount is selected to perform the settlement. That is to say, the number whose inferior of the predetermined numerical digit of the credit amount is “zero” is taken out from the credit amount, and the obtained value is taken as the fundraising amount. Or if it is the number whose predetermined numerical digit of the credit amount is greater than 5, the number whose predetermined numerical digit is 5 and whose inferior of the predetermined numerical digit is “zero” is taken out from the credit amount, and the obtained value is taken as the fundraising amount. For the illustration of the example of FIG. 12, the credit amount to which the settlement is performed is 16789, and under the condition that the predetermined numerical digit is ten, 16780 or 16750 is subtracted from the credit amount, and the obtained value 9 or 39 is the candidate of the fundraising amount displayed in the option image 1414. In addition, under the condition that the predetermined numerical digit is hundred, 16700 or 16500 is subtracted from the credit amount, and the obtained value 89 or 289 is the candidate of the fundraising amount displayed in the option image 1414. In addition, under the condition that the predetermined numerical digit is thousand, 16000 or 15000 is subtracted from the credit amount, and the obtained value 789 or 1789 is the candidate of the fundraising amount displayed in the option image 1414.

If there is a limitation to the number of the option image 1414 displayed in the display screen, the candidate of the fundraising amount may be selected as mentioned in the below. For example, the candidate in which the fundraising amount is little may be displayed in the optioned image 1414 preferentially. In addition, for example, the candidate in which the fundraising amount is great may be further displayed in the optioned image 1414 preferentially. In addition, for example, the fundraising amount may also be displayed preferentially, which is obtained by taking out the number whose inferior of the predetermined numerical digit of the credit amount from the credit amount. In addition, for example, the fundraising amount may also be displayed preferentially, which is obtained by taking out the number whose predetermined numerical digit of the credit amount is 5 and whose inferior of the predetermined numerical digit of the credit amount from the credit amount. In addition, the option image 1414 may be not displayed and only the picture causing the player to input the fundraising amount is displayed.

For example, in the example of FIG. 12, the display of the option image 1414 is limited to five. In the lower image display panel 141, five option images 1414a-1414e are configured successively from left to right. In the five option images 1414a-1414e, the option image 1414e is used to input the fundraising amount by itself, and thus, the broken number of the credit amount (the candidate of the fundraising amount) is displayed in the other four option images 1414a-1414d respectively. Under the condition of the present embodiment, the fundraising amount may also be displayed preferentially in the option images 1414a-1414d, which is obtained by taking out the number whose inferior of the predetermined numerical digit of the credit amount is “zero” from the credit amount.

In addition, in the present embodiment, the selection for the option images 1414a-1414e and the input of the fundraising amount after selecting the option image 1414e are received by the touch panel 114 disposed in the lower image display panel 141 and may also be received by the button disposed in the control panel 30.

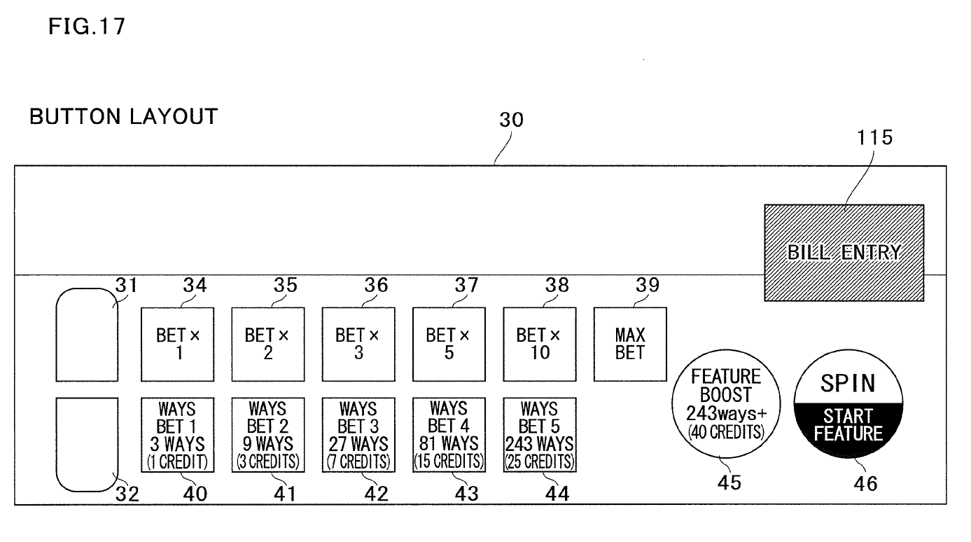

In the below, a detail illustration may be made referred to the FIG. 17. The control panel 30 comprises 1-BET button 34, 2-BET button 35, 3-BET button 36, 5-BET button 37, 10-BET button 38, WAYS BET1 button 40, WAYS BET2 button 41, WAYSBET3 button 42, WAYS BET4 button 43, and WAYS BET5 button 44.

For example, it may be configured to be that the selection for the option image 1414a is input by the 1-BET button 34 or the WAYS BET1 button 40 in the fundraising confirmation screen displaying the option images 1414a-1414e. In addition, it may be configured to be that the selection for the option image 1414b is input by the 2-BET button 35 or the WAYS BET2 button 41. In addition, it may be configured to be that the selection for the option image 1414c is input by the 3-BET button 36 or the WAYS BET3 button 42. In addition, it may be configured to be that the selection for the option image 1414d is input by the 5-BET button 37 or the WAYS BET4 button 43. In addition, it may be configured to be that the selection for the option image 1414e is input by the 10-BET button 38 or the WAYS BET5 button 44.

For example, when inputting the fundraising amount, the input of the number 0-9 may be allocated to the 1-BET button 34, 2-BET button 35, 3-BET button 36, 5-BET button 37, 10-BET button 38, WAYS BET1 button 40, WAYS BET2 button 41, WAYS BET3 button 42, WAYS BET4 button 43, and WAYS BET5 button 44. In addition, the input of the backspace and the decision may be allocated to an MAX-BET button 39 and a spin button 46 included in the control panel.

As mentioned above, in the present embodiment, the slot machine receives the second bet (the fundraising) for the second game at the settlement timing, but it is not limited thereto.

(Fundraising System: Fundraising Process)

When performing the settlement mentioned above, the slot machine 1 performs the fundraising process and performs the second game internally regarding it as the chance when the player presses the CASHOUT/TAKE WIN button 32.

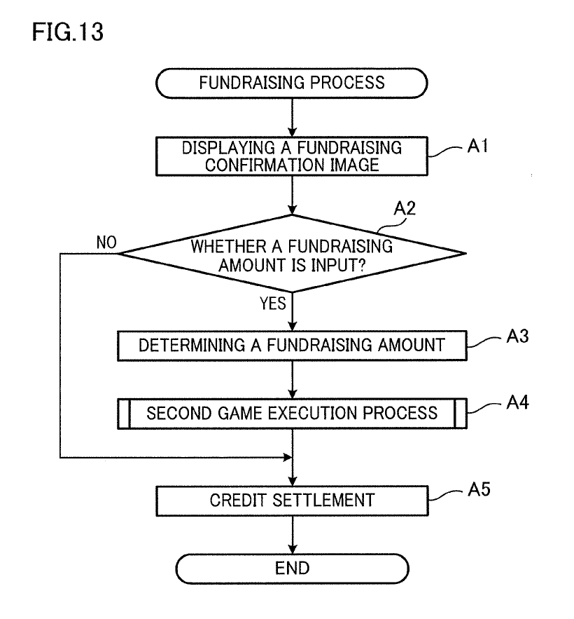

The flowchart of the fundraising process performed by the slot machine 1 is illustrated referring to FIG. 13. The fundraising process is performed mainly by an aftermentioned main CPU 71 in the slot machine 1. First of all, the main CPU 71 displays the fundraising confirmation screen as shown in FIG. 12 (A1).

Then, the main CPU 71 judges whether the input of the fundraising amount exists or not (A2). That is to say, when any one of the option images 1414 is touched, the selection of the fundraising amount is performed, or the input of the fundraising amount is performed, the main CPU 71 judges that the input of the fundraising amount exists. In addition, in the fundraising confirmation screen, if the CASHOUT/TAKE WIN button 32 is pressed again, the main CPU 71 judges that the input of the fundraising amount does not exist.

If the input of the fundraising amount exists (A2: YES), the main CPU 71 determines the fundraising amount according to the information of the touched position of the picture received by the touch panel 114 (A3). Then, the main CPU 71 performs the second game execution process (A4). As mentioned in the below, in the second game execution process, the fundraising amount is subtracted from the credit.

If it judges that the input of the fundraising amount does not exist in the step A2 (A2: NO), or after the step A4, the main CPU 71 performs a credit settlement (A6). That is to say, if the fundraising is to be performed, the settlement is performed to the value obtained by subtracting the fundraising amount from the credit, and if the fundraising is not performed, the settlement is performed to the credit directly.

(Fundraising System: The Second Game Execution Process)

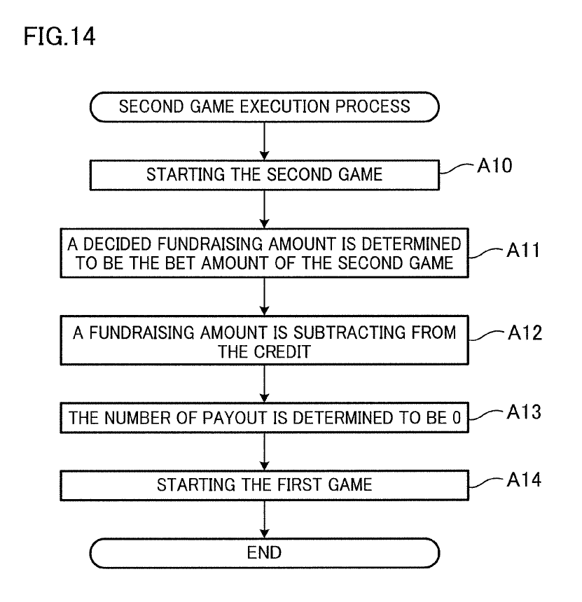

The flowchart of the second game execution process performed by the slot machine 1 is illustrated referring to FIG. 14. The second game execution process is mainly a communication process with the host server 200 performed by the aftermentioned main CPU 71 in the slot machine 1.

First of all, the main CPU 71 starts the second game (A10). To be more specific, the main CPU 71 sends the exception code signal to the host server 200, and the exception code signal is used to denotes that the game has been selected (referring to FIG. 8). Then, the main CPU 71 receives a long poll signal of code “55” from the host server 200, which is used to require the game number of the selected game, and the host server 200 has received the exception code signal including the exception code “8C” therein. Then, as a response to the long poll signal of code “55”, the main CPU 71 sends the gaming machine message signal to the host server 200, and a game number “9999” which is used to denote the second game in set in the gaming machine message signal.

Next, the main CPU 71 determines the decided fundraising amount for the bet amount of the second game (A11). Then, the main CPU 71 subtracts the fundraising amount from the credit (A12). To be more specific, the main CPU 71 sends the exception code signal to the host server 200, and the bet amount equal to the decided fundraising amount in the exception code signal, denoting that the game has started (referring to FIG. 6). Then, the main CPU 71 receives a long poll signal of code “11” from the host server 200, which is used to require the value of the total Coin In meter (the credit amount), and the host server 200 has received the exception code signal including the exception code “7E” therein. Then, as a response to the long poll signal of code “11”, the main CPU 71 sends the gaming machine message signal to the host server 200, the total Coin In meter is set in the gaming machine message signal, and the total Coin In meter is equal to the credit amount after subtracting the bet amount (the fundraising amount) (referring to FIG. 11). In addition, the main CPU 71 further performs a fundraising amount subtracting process to the credit stored within the slot machine 1, and the fundraising amount is stored accumulatively as the credit for the fundraising into the aftermentioned RAM 73, etc.

Next, the main CPU 71 determines the number of payout to be zero (A13). To be more specific, as the exception code signal, the main CPU 71 sends the exception code signal which is used to denote that the game has been terminated to the host server 200 (referring to FIG. 7). The exception code signal comprises an exception code “7E” denoting that the game is terminated and information denoting that the game win (the number of payout) is “zero”.

Then, the main CPU 71 starts the first game (A14). To be more specific, the main CPU 71 sends the exception code signal to the host server 200, and the exception code signal is used to denotes that the first game has been selected (referring to FIG. 8). Then, the main CPU 71 receives a long poll signal of code “55” from the host server 200, which is used to require the game number of the selected game, and the host server 200 has received the exception code signal including the exception code “8C” therein. Then, as a response to the long poll signal of code “55”, the main CPU 71 sends the gaming machine message signal to the host server 200, and a game number “0001” which is used to denote the first game in set in the gaming machine message signal (referring to FIG. 10). Thereafter, the routine is terminated.

(Fundraising System: The Host Server)

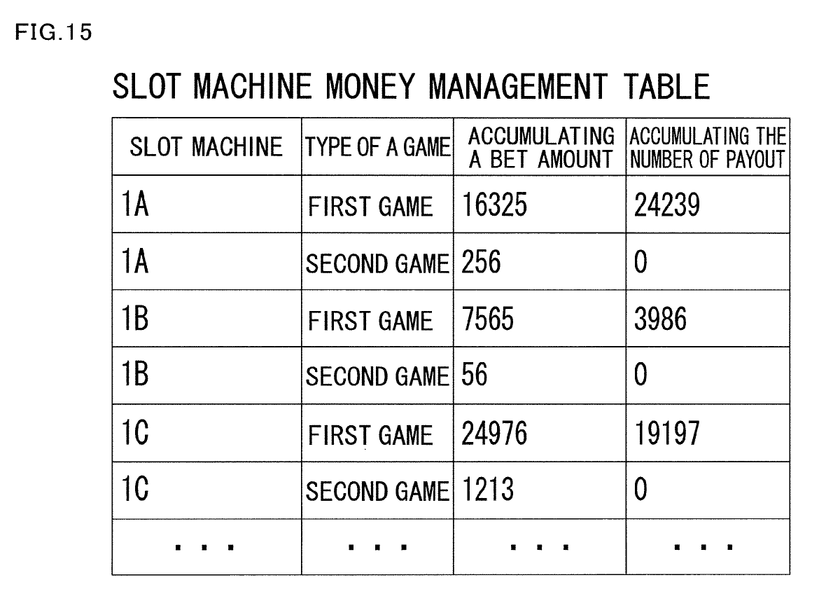

FIG. 15 is a slot machine money management table stored by the host server 200. As shown in FIG. 15, the host server 200 comprises a management table, and the management table manages the input/output of the credit in the slot machine 1 according to the exception code signal and the gaming machine message signal sent by a plurality of slot machines 1.

The slot machine money management table comprises a slot machine column, a game type column, a bet amount accumulating column, and a number of payout accumulating column. The address of the slot machine which is used to recognize the slot machine is preserved in the slot machine column. The second game and the game number which is used to recognize the second game are preserved in the game type column. In the bet amount accumulating column, the accumulative amount of the bet of the whole game conducted so far is preserved according to the type of the game. In the number of payout accumulating column, the accumulative amount of the number of payout of the whole game conducted so far is preserved according to the type of the game.

As mentioned above, the bet amount accumulation is calculated and stored according to the type of the game, and thus the sum of the fundraising in the whole slot machines 1A, 1B, 1C, is calculated by accumulatively calculating the sum of the bet amount of the second game in the whole slot machines 1A, 1B, 1C, . . . .

(Overall Structure of the Slot Machine)

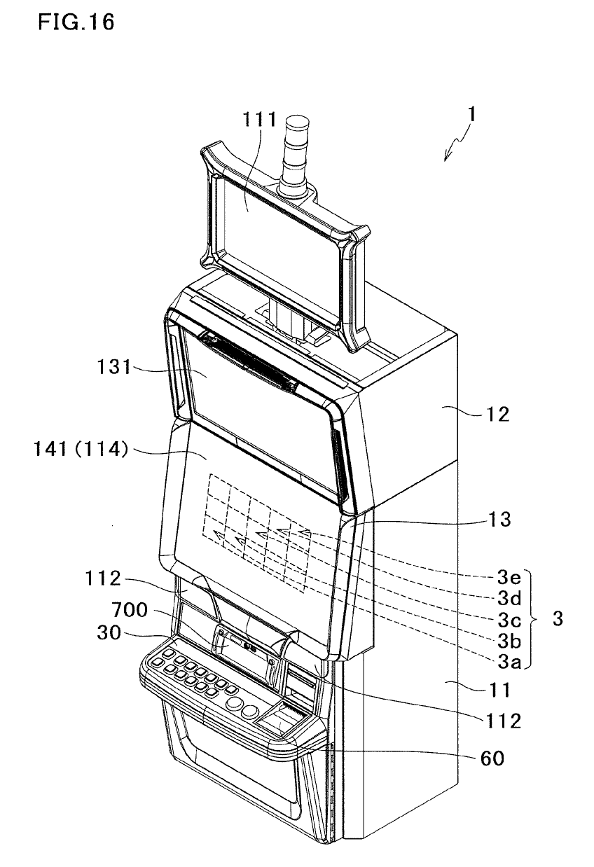

Next, refer to the FIG. 16, the overall structure of the slot machine is illustrated. FIG. 16 is an illustrative diagram showing the overall structure of the slot machine of an embodiment of the present invention.

In the slot machine 1, electronic information of price such as an electronic money and the like is adopted as a gaming value. Further, the gaming value is not limited thereto, for example, a coin, a medal, a token, a ticket with a bar code and the like may also be adopted.

The slot machine 1 comprises a cabinet 11, a top box 12 disposed on the upper side of the cabinet 11, and a main door 13 disposed on the front surface of the cabinet 11. In addition, a digital signage 11 is disposed on the top box 12.

The lower image display panel 141 is disposed at the center of the main door 13. The lower image display panel 141 is constituted of a liquid crystal panel, which forms a display. The lower image display panel 141 comprises a symbol display area 4. Five array areas (first array area-fifth array area) are disposed in the symbol display area 4, and each of the array areas is divided into three areas, that is, an upper stage, a middle stage and a lower stage. Besides, the first array area-fifth array area displays video reels 3 (3a, 3b, 3c, 3d, 3e) respectively. In the embodiment of the present invention, the so-called video reel refers to the operation showing the rotating and stopping of a mechanical driven type reel by an image, and wherein a plurality of symbols are depicted on the circumferential surface of the mechanical driven type reel. The video reels 3 are allocated with a symbol array which is constituted of a plurality of symbols.

In the symbol display area 4, the symbol array which is allocated to the video reels 3 (3a, 3b, 3c, 3d, 3e) is scrolled respectively and stopped after a predetermined time. As a result, a portion of respective symbol array (the sequential three symbols in the embodiment of the present invention) is displayed in the symbol display area 4. In the first array area-fifth array area of the symbol area 4, the three areas of the upper stage, the middle stage and the lower stage display one symbol respectively corresponding to the video reels 3a, 3b, 3c, 3d, 3e. In the symbol display area 4, fifteen symbols (5 columns×3 rows) are displayed.

In the embodiment of the present invention, the winning is determined with a manner of “LEFT TO RIGHT”. To be more specific, first of all, an area which will become the target of the result determination is determined from the fifteen areas of 5 columns×3 rows of the symbol display area 4 by selecting the WAYS (WAYS BET1, WAYS BET2, WAYS BET5, WAYS BET4, WAYS BET5) of the five stages. Then, if the symbols which stop in the area which has become the target of the result determination have a predetermined number of the symbols sequencing together in a range from the first array area to the fifth array area, it is the winning.

In addition, the touch panel 114 is disposed within the lower image display panel 141. Various instructions may be input by a player through touching the lower image display panel 141.

In addition, in the present embodiment, a video reel type displaying a simulated reel is adopted. However, the slot machine 1 may also be a manner of a mechanical driven type of a reel unit, and may also be a manner of a combination of the video reel type and the mechanical driven type.

An upper image display panel 131 is disposed on the front surface of the top box 12. The upper image display panel 131 is constituted of a liquid crystal panel, which forms a display. The upper image display panel 131 displays an image related to the effect, an introduction of the game contents, and an image illustrating the rule.

A control panel 30 configured with various buttons therein, a PTS device 700 and a bill entry 60 (corresponding to an input device) are disposed beneath the lower image display panel 141.

The bill entry 60 is used to recognize whether the bill meets the rule and put the genuine bill into the cabinet 11. The bill entry 60 is electrically connected with the PTS device 700, which sends an input signal based on the amount of the genuine bill to the PTS device 700 when receiving the genuine bill. The input signal contains information related to the credit data of the received bill and the like.

The PTS device 700 is an LCD (liquid crystal display), a human detection camera, a microphone and other integrated unit. The human detection camera may detect whether there is a player or not through a camera function. The application of the microphone is that a player takes part in a game by the sound, or an identification of a player is performed through the sound recognition. In addition, a card insertion slot is disposed in the PTS device 700 to insert an IC card. Therefore, a player may insert an IC card into the card insertion slot such that the credit stored in the IC card is used in the slot machine 1.

(Control Panel 30)

As shown in FIG. 17, in the control panel 30, a CHANGE button 31 and the CASHOUT/TAKE WIN button 32 are arranged in the left area oppositely, and the 1-BET button 34, 2-BET button 35, 3-BET button 36, 5-BET button 37, 10-BET button 38, MAX-BET button 39, WAYS BET1 button 40, WAYS BET2 button 41, WAYS BET3 button 42, WAYS BET4 button 43, WAYS BET5 button 44 are arranged in the center area oppositely. In addition, the bill entry 115 which is used to receive the bill is arranged in the upper stage of the right area, and a FEATURE BOOST button 45 and the spin button 46 are arranged in the lower stage of the right area.

The CHANGE button 31 is an operation button which is used when a staff person who leaves the seat or requests a gaming facility performs an exchange. The CASHOUT/TAKE WIN button 32 is an operation button used when performing the settlement to the coin (the credit) stored within the slot machine 1.

As mentioned above, the WAYS BET1 button 40, the WAYS BET2 button 41, the WAYS BET3 button 42, the WAYS BET4 button 43, the WAYS BET5 button 44 are buttons which are used to determine the area which will become the target (activate) of the result determination from the total fifteen areas of 5 columns×3 rows of the symbol display area 4. In addition, under the condition that the area which will become the target of the result determination is determined by the WAYS BET1 button 40, one credit is needed. In addition, under the condition that the area which will become the target of the result determination is determined by the WAYS BET2 button 41, three credits are needed. In addition, under the condition that the area which will become the target of the result determination is determined by the WAYS BET3 button 42, seven credits are needed. In addition, under the condition that the area which will become the target of the result determination is determined by the WAYS BET4 button 43, fifteen credits are needed. In addition, under the condition that the area which will become the target of the result determination is determined by the WAYS BET5 button 44, twenty-five credits are needed.

In addition, the FEATURE BOOST button 45 is a button which is used to start the FEATURE BOOST function. To be more specific, when the FEATURE BOOST button 45 is pressed, like the WAYS BET5 button 44, the upper stage, the middle stage, and the lower stage of the first array area, the upper stage, the middle stage, and the lower stage of the second array area, the upper stage, the middle stage, and the lower stage of the third array area, the upper stage, the middle stage, and the lower stage of the fourth array area, and the upper stage, the middle stage, and the lower stage of the fifth array area of the symbol display area 4 become the target (activate) of the result determination, and thus the FEATURE BOOST function is enable. In the present embodiment, when the FEATURE BOOST function is enable, if a free game trigger comes into existence, a predetermined number of free game is additionally given by the random determination (a detailed description will be shown in the below). An area which will become the target of the result determination is determined by the FEATURE BOOST button 45, and under the condition that the FEATURE BOOST function is enable, forty credits are needed.

The 1-BET button 34 is a button which is used to determine the multiplying factor to be equal to the payout (1 BET). In addition, the 2-BET button 35 is a button which is used to determine the multiplying factor to be double of the payout (2 BET). In addition, the 3-BET button 36 is a button which is used to determine the multiplying factor to be triple of the payout (3 BET). In addition, the 5-BET button 37 is a button which is used to determine the multiplying factor to be quintuple of the payout (5 BET). In addition, the 10-BET button 38 is a button which is used to determine the multiplying factor to be tenfold of the payout (10 BET). In addition, the 10-BET button 38 is a button which is used to determine the multiplying factor to be four hundred times of the payout (400 BET).

In the present embodiment, the credit amount which is to be bet is determined by the selection for the six stages (the WAYS BET1, the WAYS BET2, the WAYS BET3, the WAYS BET4, the WAYS BET5, and the FEATURE BOOST) mentioned above and the selection for the six BET button (the 1-BET button 34, the 2-BET button 35, the 3-BET button 36, the 5-BET button, the 10-BET button 38, and the MAX-BET button 39), and thus the unit game starts.

For example, the credit required by the WAYS BET1 (the WAYS BET1 requires one credit, the WAYS BET2 requires three credits, the WAYS BET3 requires seven credits, the WAYS BET 4 requires fifteen credits, the WAYS BET5 requires twenty-five credits, and the FEATURE BOOST requires forty credits) multiplied by the credit value corresponding to the BET button obtains the credit amount which is bet when starting the unit game. For example, under the condition that the WAYS BET1 button 40 and the 2-BET button 35 are selected, the bet is “1”×“2”=2 credits. In addition, under the condition that the WAYS BET3 button 42 and the 3-BET button 36 are selected, the bet is “7”×“3”=21 credits. In addition, under the condition that the WAYS BET5 button 44 and the 10-BET button 38 are selected, the bet is “25”×“10”=250 credits.

The spin button 46 is a button which is used when causing the video reels 3 (3a, 3b, 3c, 3d, 3d) to start to scroll. In addition, the spin button 46 is a button which is used when the options displayed in the lower image display panel 141 are selected.

The bill entry 115 is used to recognize whether the bill meets the rule and put the genuine bill, the ticket with a bar code and the like into the cabinet 11.

(A Circuit Structure Comprised in the Slot Machine)

Next, refer to the FIG. 18, a circuit structure comprised in the slot machine 1 is illustrated. FIG. 18 is a block diagram showing an internal structure of a slot machine of an embodiment of the present invention.

A gaming board 50 includes a CPU 51, a ROM 52 and a boot ROM 53 connected with each other through an internal bus, a card slot 55 corresponding to the memory card 54, and an IC socket 57 corresponding to a GAL (GENERIC ARRAY LOGIC) 56.

The memory card 54 is constituted of a Non-volatile memory, storing a game program and a game system program. The game program includes a program related to a game progression, a random determination program, and a program of an effect of a sound. In addition, the data of the structure of the symbol array which is set to allocate to the video reels 3 and the like are comprised in the game program mentioned above.

The random determination program is a program which is used to determine a to-be-stopped symbol of the video reels 3a, 3b, 3c, 3d, and 3e through the random determination. The to-be-stopped symbol is a data which is used to determine three symbols displayed in the symbol display area 4 from a plurality of symbols constituting the symbol array. The slot machine 1 of the present embodiment determines the symbols displayed in the predetermined area (for example, the middle stage area) to be the to-be-stopped symbols from three areas of the symbol display area 4 corresponding to the video reels 3a, 3b, 3c, 3d, and 3e. Therefore, the symbols of the symbol display area 4 which are displayed in three areas (the upper stage area, the middle stage area, and the lower stage area) corresponding to the video reels 3a, 3b, 3c, 3d, and 3e.

The random determination program mentioned above includes a symbol determination data. The symbol determination data is that the random number is set according to the video reels 3a, 3b, 3c, 3d, and 3e such that a plurality of symbols constituting the symbol array are determined with a same probability respectively. For example, in the first reel (Reel 1) 3a of the normal mode video reels 3, the random number may be set to determine 26 symbols (code number “0”-“25”) constituting the symbol array with a same probability respectively, and the random number may also be set to determine them with different probabilities respectively.

In addition, the card slot 55 is configured to insert and extract the memory card 54, and connected onto a motherboard 70 via an IDE bus.

The GAL 56 is one of PLD (Programmable Logic Devices) comprising an OR fixed type array structure. The GAL 56 comprises a plurality of input ports and output ports, and when a predetermined input occurs at the port, a corresponding data is output from the output port.

In addition, the IC socket 57 is configured to be able to cause the GAL 56 to perform a removing and installing with respect to the IC socket 57, and the IC socket 57 is connected onto the motherboard 70 via a PCI bus. The game contents which are conducted in the slot machine 1 may be changed by replacing the memory card 54 with a memory card in which other different program is written or re-writing the program in the memory card 54 to be other different program.

The CPU 51, the ROM 52 and the boot ROM 53 connected through the internal bus are connected onto the motherboard 70 through the PCI bus. The PCI bus performs a signal transduction between the motherboard 70 and the gaming board 50, and performs a power distribution from the motherboard 70 to the gaming board 50.

The ROM 52 is used to store an authentication program. The boot ROM 53 stores the authentication program, a program (boot code) which is used to cause the CPU 51 to start the authentication program and the like. The authentication program is a program (falsification check program) used to authenticate a game program and a game system program. The preliminary authentication program is a program used to authenticate the above authentication program. The authentication program and the preliminary authentication program perform a description according to a procedure (authentication procedure) which is used to authenticate the fact that the target program is not falsified.

The motherboard 70 comprises a main CPU 71, a ROM 72, a RAM 73, a communication interface 82. The ROM 72 and the RAM 73 function as a memory device.

The ROM 72 is constituted of a memory device such as a flash memory, storing a program such as a BIOS executed by the main CPU 71 and a permanent data. When the BIOS is executed by the main CPU 71, an initialization process is performed to a predetermined peripheral device. In addition, a taking-into process is performed to the game program and the game system program stored in the memory card 54 through the gaming board 50.

Besides, a processor of the present invention is configured to include the above main CPU 71, ROM 72, RAM 73 and memory card 55 storing the game program and the game system program, and the slot machine is controlled through the main CPU 71 executing the game program and the game system program. The processor mentioned above is not limited thereto, and it may adopt a structure in which the game program and the game system program is pre-stored in the ROM 72 but not the memory card 54.

A data and a program which are used when the main CPU 71 performs an operation are stored in the RAM 73. For example, the game program, the game system program and the authentication program mentioned above may be stored when a taking-into process is performed to them. Further, a working area which works when the above program is executed is disposed in the RAM 73. For example, a memory area for storing game times, a BET, a payout amount, a credit amount and the like, a region for storing a symbol (code number) determined by a random determination and the like are disposed.

In addition, a door PCB (Printed Circuit Board) 90 and a main body PCB 110 are connected onto the motherboard 70 via a USB respectively.

An input device such as a switch and a sensor and a peripheral device are connected onto the door PCB 90 and the main body PCB 110, and wherein the operation of the peripheral device is controlled by the main CPU 71. A control panel 30 and a cold cathode tube 93 are connected onto the door PCB 90.

Corresponding to the respective buttons mentioned above, a CHANGE switch 31S, a CASHOUT switch 32S, a 1-BET switch 34S, a 2-BET switch 35S, a 3-BET switch 36S, a 5-BET switch 37S, a 10-BET switch 38S, an MAX-BET switch 39S, a WAYS BET1 switch 40S, a WAYS BET2 switch 41S, a WAYS BET3 switch 42S, a WAYS BET4 switch 43S, a WAYS BET5 switch 44S, a FEATURE BOOST switch 45S, a spin switch 46S are disposed on the control panel 30. Various switches detect that corresponding buttons are pressed by a player and output a signal to the main CPU 71.

The cold cathode tube 93 operates as a backlight which is disposed on the back sides of the upper image display panel 131 and the lower image display panel 141, and lights up according to a control signal output by the main CPU 71.

A digital signage 111, a speaker 112, a touch panel 114, a graphic board 130, a power supply unit 81, and a communication interface 82 are connected onto the main body PCB 110.

The digital signage 111 lights up according to the control signal output by the main CPU 71. The speaker 112 outputs a sound such as the BGM and the like according to a control signal output from the main CPU 71.

The touch panel 114 detects a position touched by a finger and the like on the lower image display device 141 and outputs a signal corresponding to the detected position to the main CPU 71.

The graphic board 130 controls the image display performed by the upper image display panel 131 and the lower image display panel 141 respectively according to the control signal output by the main CPU 71. The symbol display area 4 of the lower image display panel 141 displays five video reels 3a, 3b, 3c, 3d, and 3e, and displays the operation of scrolling and stopping of the symbol array comprised in the video reels 3a, 3b, 3c, 3d, and 3e. The above graphics board 130 includes a video RAM for storing a VDP generating an image data, and the image data generated by the VDP and the like.

In addition, the graphics board 130 includes a video RAM for temporarily storing a VDP (Video Display Processor) generating an image data, and the image data generated by the VDP according to the control output by the main CPU 71 and the like. In addition, an image data adopted when the VDP generates the image data is included within a game program, and the game program is read out from the memory card 55 and is stored in the RAM 73.

The power supply unit 81 performs a power distribution to the slot machine 1. When the power supply unit 81 performs the power distribution to the motherboard 70, the main CPU 71 of the motherboard 70 starts, and a power distribution is performed to the gaming board 50 by the PCI bus such that the CPU 51 starts.

The communication interface 82 is used to communicate with the PTS device 700 and the host server 200. The PTS device 700 sends a credit data included in an input signal to the main CPU 71 through the communication interface 82 after accepting the input signal from the bill entry 115. When the IC card is inserted into the card insertion slot, the PTS device 700 sends the credit data stored in the IC card to the main CPU 71 via the communication interface 82. In addition, the PTS device 700 writes a credit data to the IC card which is inserted into the card insertion slot according to the control signal received from the main CPU 71 via the communication interface 82.

(The Symbol Array of the Video Reel)

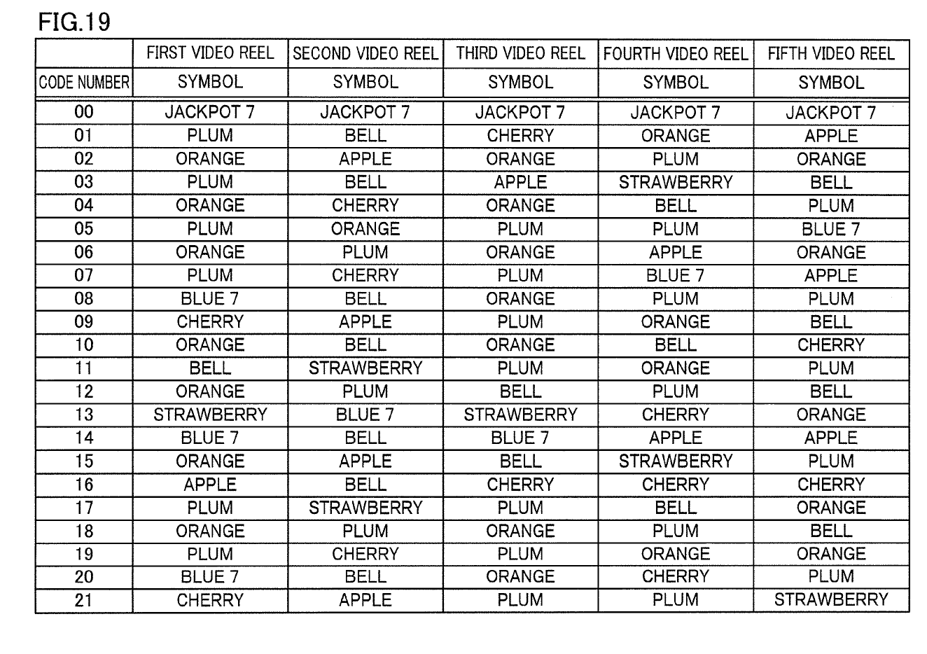

The above is an illustration for the overall structure of the gaming machine 1. Next, refer to the FIG. 19, the symbol array comprised in the video reels 3 of the slot machine 1 is illustrated. The first video reel 3a, the second video reel 3b, the third video reel 3c, the fourth video reel 3e, and the fifth video reel 3d are allocated with a symbol array respectively, and the symbol array is constituted of twenty-two symbols corresponding to the code number “00”-“21”. As the type of the symbol, a “JACKPOT 7”, a “BLUE 7”, a “BELL”, a “CHERRY”, a “STRAWBERRY”, a “PLUM”, an “ORANGE” and an “APPLE” are disposed.

(The Structure of the Symbol Combination Table)

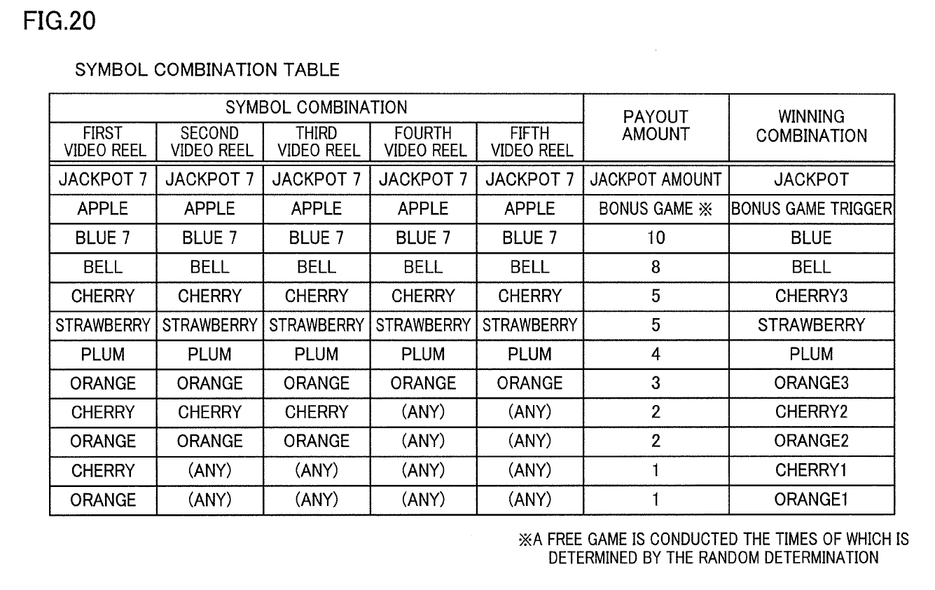

The above is an illustration for the circuit structure of the gaming machine 1. Next, the symbol combination table is illustrated referring to the FIG. 20.

A picture combination of the symbols related to a winning and the payout amount are set in the symbol combination table. In the gaming machine 1, when the scroll of the symbol array of the respective video reels 3 stops and the combination of the symbols displayed on the winning line is in keeping with the combination of the symbols set by the symbol combination table, the winning comes into existence. Then, a benefit is given to a game player according to the winning combination, and for example, the benefit includes a payout of the coin, starting a bonus game, and the like. In addition, if the combination of the symbols displayed on the winning line is not in keeping with the combination of the symbols set by the symbol combination table, the winning does not come into existence (the so-called game miss).

Basically, if the respective symbols of the “JACKPOT 7”, the “APPLE”, the “BULLE 7”, the “BELL”, the “CHERRY”, the “STRAWBERRY”, the “PLUM” and the “ORANGE” are totally displayed on the winning line through the video reels 3, the winning comes into existence. However, if the respective symbols of the “CHERRY” and the “ORANGE” are displayed on the winning line through one or three video reels 3, the winning also comes into existence under this condition.

For example, if the symbol “BLUE” is displayed on the winning line by all video reels 3, the winning combination is “BLUE”, and the payout amount is determined to be “10”. Then, the payout of the coin is performed according to the determined payout amount. Regarding the payout of the coin, it may be implemented by issuing the coin from a coin payout exit 15A actually, or adding it into the credit amount, or delivering a bar code ticket.

The “JACKPOT 7” is a jackpot trigger. If the symbol “JACKPOT 7” is displayed on the winning line by all video reels 3, the winning combination is “JACKPOT 7”, and the payout amount is determined to be a jackpot amount.

The “APPLE” is a bonus game trigger. If the symbol “APLLE” is displayed on the winning line by all video reels 3, the winning combination is “bonus game”, and a bonus game will be conducted from the next game.

(Program Contents)

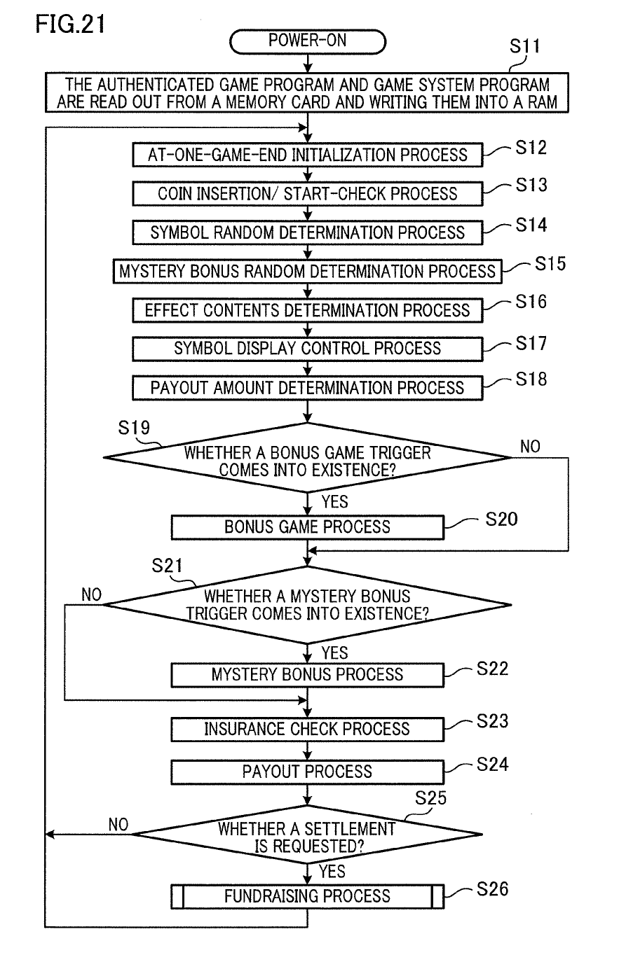

The above is an illustration for the symbol combination table. Next, refer to the FIG. 21, a program executed by the gaming machine 1 is illustrated.

(Main Control Process)

Refer to the FIG. 21, the main control process is illustrated. In the main control process, a process related to the first game (the normal game) is mainly performed. In addition, the second game execution process illustrated in the FIG. 14 must be terminated after the first game starting, and thus, in the present routine, a selection process of the first game is not performed (a process of sending an exception code signal to the host server 200, and the exception code signal is used to denote the selected first game; and a process of sending a gaming machine message signal to the host server 200, and a game number “0001” which is used to denote the first game is set in the gaming machine message signal).

First, the main CPU 71 reads a game program and a game system program which have been certificated from the memory card 54 through the gaming board 50, and the game program and the game system program are written into the RAM 73, when the gaming machine 1 is power-on (this step is referred as S11 for short in the below).

Next, the main CPU 71 performs an at-one-game-end initialization process (S12). For example, the data (for example, a symbol determined by a bet amount and a random determination, and the like) which is not required by each game in the working area of the RAM 73 is cleared.

Next, the main CPU 71 performs a coin insertion/start-check process (S13). In this process, an input check of the BET switch and the spin switch 46S and the like are performed. In addition, in this process, the main CPU 71 sends the determined bet amount to the host server 200. To be more specific, the main CPU 71 sends the exception code signal to the host server 200, and the bet amount equal to the decided fundraising amount in the exception code signal, denoting that the game has started (referring to FIG. 6). Then, the main CPU 71 receives a long poll signal of code “11” from the host server 200, which is used to require the value of the total Coin In meter (the credit amount), and the host server 200 has received the exception code signal including the exception code “7E” therein. Then, as a response to the long poll signal of code “11”, the main CPU 71 sends the gaming machine message signal to the host server 200, the total Coin In meter is set in the gaming machine message signal, and the total Coin In meter is equal to the credit amount after subtracting the bet amount (the fundraising amount) (referring to FIG. 11). In addition, the main CPU 71 further performs a bet amount subtracting process to the credit stored within the slot machine 1.

Next, the main CPU 71 executes a symbol random determination process (S14). In this process, a to-be-stopped symbol is determined according to a symbol determination-use random number.

Next, the main CPU 71 executes a mystery bonus random determination process (S15). In this process, the random determination is performed to determine whether the mystery bonus trigger is caused to come into existence. For example, the main CPU 71 extracts a mystery bonus-use random number in the range of “0-99”, and when the extracted random number is “zero”, the mystery bonus trigger is caused to come into existence.

Next, the main CPU 71 executes an effect contents determination process (S16). The main CPU 71 extracts an effect-use random number, and a certain effect content is determined from a plurality of effect contents which are set in advance by the random determination.

Next, the main CPU 71 executes a symbol display control process (S17). In this process, the symbol array of the respective reels 3 starts to scroll, and the to-be-stopped symbol which is determined in the symbol random determination process of S14 stops at a predetermined position (for example, at the upper stage area of the symbol display area 4). That is to say, four symbols including the to-be-stopped symbol are displayed in the symbol display area 4. For example, the to-be-stopped symbol is a symbol of the code number “10”, and if it is displayed in the upper stage area, the respective symbols of the code numbers “11”, “12”, and “13” will be displayed in the upper middle stage, the lower middle stage, and the lower stage of the symbol display area 4 respectively.

Next, the main CPU 71 executes a payout amount determination process (S18). In this process, the payout amount is determined and is stored in the payout counter which is disposed in the RAM 73, according to the combination of the symbols displayed on the winning line L.

Next, the main CPU 71 judges whether the bonus game trigger comes into existence or not (S19). When the main CPU 71 judges that the bonus game trigger comes into existence, a bonus game process is performed (S20).

Next, the main CPU 71 judges whether the mystery bonus trigger comes into existence or not after the process of S20 or when it is judged that the bonus game trigger does not come into existence in S19 (S21). When the main CPU 71 judges that the mystery bonus trigger comes into existence, a mystery bonus process is performed (S22). In this process, the payout amount (for example, 300) which is set to be the mystery bonus-use is saved in the payout amount counter which is disposed in the RAM 73.

The main CPU 71 performs an insurance check process after the process pf S22 or when it is judged that the mystery bonus trigger does not come into existence in S21 (S23). In this process, it is checked whether a payout based on the insurance is performed.

Next, the main CPU 71 executes a payout process (S24). The main CPU 71 adds a value saved in the payout amount counter into a credit counter, and the credit counter is disposed in the RAM 73. In addition, it may also be configured to control the driving for a hopper 113 according to the input of the CASHOUT switch 33S, issuing the coin corresponding to the value saved in the payout amount counter from the coin payout exit 15A. In addition, it may also be configured to control the driving for a ticket printer 171, delivering a ticket with a bar code, and the value saved in the payout amount counter is recorded in the ticket with the bar code. In addition, in this process, the main CPU 71 sends the determined payout amount to the host server 200. To be more specific, as the exception code signal, the main CPU 71 sends the exception code signal which is used to denote that the game has been terminated to the host server 200 (referring to FIG. 7). The exception code signal comprises an exception code “7E” denoting that the game is terminated and information denoting the determined game win (the number of payout).

Next, the main CPU 71 judges whether a player has requested a settlement or not (S25). If the settlement has been requested (S25: YES), the fundraising process illustrated in the FIG. 14 is performed (S26). On the other hand, if the settlement is not requested (S25: NO), or after the step S26, entering S12.

The above embodiments thus described solely serves as specific examples of the present invention, and the present invention is not limited to such examples. Specific configurations of various means may be suitably designed or modified. Further, the effects of the present invention described in the above embodiments are not more than examples of most preferable effects achievable by the present invention. The effects of the present invention are not limited to those described in the embodiments described above.

Further, the detailed description above is mainly focused on characteristics of the present invention to fore the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine, comprising: a first bet receiving device receiving a first bet for starting a first game;
a second bet receiving device receiving a second bet for starting to conduct a second game; and
a controller performing the following process,
the controller
performing a random determination with a predetermined winning probability and outputting a result of the second game after the first bet receiving device receiving the first bet,
outputting a result of the second game which is certainly not the lucky number after the second bet receiving device receiving the second bet.

2. The gaming machine according to the claim 1, wherein further comprising a storage unit,
the controller calculating an accumulative value of a bet amount in the second game,
the storage unit storing the accumulative value calculated by the controller.

3. The gaming machine according to the claim 2, wherein,
the controller allowing to receive the second bet at a settlement timing.

4. The gaming machine according to the claim 3, wherein,
the controller
storing a payout into a credit accumulatively under a condition of the result of the first game being to give the payout, and wherein the credit is to be stored in the storage unit,
prompting a broken number of the credit as an option of the bet amount of the second bet when starting the second game.

5. A game system, wherein,
comprising a plurality of gaming machines which may perform various games including certain games each of which is certainly not the lucky number, and a host server connected with the plurality of gaming machines with a manner of being able to perform a data communication and managing money information of the plurality of gaming machines,
the plurality of gaming machines respectively
sending a type of the game which is conducted and a bet amount and a number of payout in the game which is conducted to the host server,
the host server calculating a bet amount and a number of payout received from the plurality of gaming machines for each of the games and storing the bet amount and the number of payout.

6. A game system, wherein,
comprising a plurality of gaming machines which may perform various games including certain game, and a host server connected with the plurality of gaming machines with a manner of being able to perform a data communication and managing money information of the plurality of gaming machines,
the plurality of gaming machines respectively comprising:
a storage unit which is used to store the plurality of games including the certain game; and
a controller which is used to perform the following process,
the controller
sending a command to the host server when starting the certain game, and the command contains a bet amount, a credit amount after the bet amount is subtracted and an information of a content indicating that the certain game is to start,
sending a command to the host server when terminating the certain game, and the command contains a game result which is used to indicate that it is no payout all the time and an information which is used to indicate that the certain game is to be terminated.
